(19) United States
(12) Patent Application Publication
(10) Pub. No.: US 2013/0165077 A1
(43) Pub. Date: Jun. 27, 2013

(54) METHOD AND APPARATUS FOR IDENTIFYING FAKE NETWORKS

(71) Applicant: Samsung Electronics co., Ltd., Gyeonggi-do (KR)

(72) Inventors: Kedar Santosh Kumar AALLA, Bangalore (IN); Nirlesh Kumar Koshta, Bangalore (IN); Siddharth Mishra, Bangalore (IN)

(73) Assignee: Samsung Electronics co., Ltd., Gyeonggi-do (KR)

(21) Appl. No.: 13/723,785

(22) Filed: Dec. 21, 2012

(30) Foreign Application Priority Data
Dec. 23, 2011 (IN) 4552/CHE/2011

(51) Int. Cl. H04W 12/06

(52) U.S. Cl. 455/411

(57) ABSTRACT

A method and a User Equipment (UE) for identifying fake 3G/LTE networks is disclosed. The method includes starting a timer corresponding to an authentication failure; determining if a fresh request for authentication is received from a network; checking if there is an authentication failure in a lower layer if the fresh request is not received from the network; stopping the timer if there is the authentication failure in the lower layer; updating a count value for the authentication; comparing the count value with a pre-set value; and barring a cell if the count value is greater than the pre-set value.

### PRIORITY

This application claims priority under 35 U.S.C. §119(a) to an Indian Patent

Application filed in the Indian Patent Office on Dec. 23, 2011 and assigned Serial No. 4552/CHE/2011, the contents of which is incorporated herein by reference.

### BACKGROUND

1. Field of the Invention

The present invention relates to the field of communication networks, and more particularly, to detection of fake networks.

2. Description of the Related Art

Mobile communication networks enable a plurality of wireless communication devices to establish contacts with each other through a network and exchange information. During exchange of such information, security concerns arise. In present day systems, the security of connectivity, data and so on is ensured by means of authentication of the User Equipment (UE) at the network.

With advancements in technology, Next Generation Networks (NGNs) such as third Generation (3G) networks and Long Term Evolution (LTE) networks have been introduced. Further, the 3G networks enable network operators to offer a wider range of advanced services to users while achieving greater network capacity through improved spectral efficiency. The services offered by 3G networks include wide-area wireless voice telephony, video calls, and broadband wireless data, all in a mobile environment. In addition, 3G networks also support high uplink and downlink speeds. 3G networks offer a great deal of security over communication as compared to their predecessors. 3G networks offer two way security and authentication i.e., in 3G networks, the authentication process is performed at the level of the network as well as at the User Equipment (UE), unlike its predecessors that provide only network level authentication. By allowing the UE to authenticate the network it is attaching to, the UE can be sure that the network is the intended one and not an impersonator or a fake network. Further, 3G networks use multiple cipher and integrity measures to ensure data security. However, in spite of the aforementioned measures, there is a possibility that 3G networks are prone to threats and attacks from fraudulent networks.

The current handling of the authentication process in 3G networks possesses certain drawbacks, such as for example, in the operation of authentication timers in 3G networks. During the registration process, the UE receives an authentication request from the network and the Subscriber Identity Module (SIM) that resides on the UE responds to the request. In cases of authentication failure (that may be due to several reasons) the SIM on the UE sends an authentication failure response to the network. The UE then starts a timer and waits for another authentication request from the network. The timer may vary according to the type of failure. While the timer is running, if there is a lower layer failure due to a weak signal condition, then a Radio Resource Connection (RRC) will be aborted abnormally. Now since the authentication timer is still running at the UE end, at the expiry of the timer the behavior of the currently camped cell is indeterminate. This may result in a false notion at the UE and the UE may bar the currently camped cell. This may be a severe drawback as the network behavior may not be proper since it is possible that the network has sent an authentication request to the UE but because of the lower layer failure at the UE, the UE was not able to receive it consecutively, barring the camped cell. There may be a possibility that the barred cell is a genuine cell, and due to failures at the UE, the cell resource is no longer used and hence wasted.

Further, if the UE ignores the expiry of authentication timer then it is possible that a fake 3G network stops a genuine user from using the genuine service as follows. The fake network after receipt of authentication failure may lower the signal strength so that there is an abnormal lower layer failure happening at the UE. After some time it again increases the signal strength so that UE again camps back onto the fake network cell. In the above scenario, the UE will be stuck in an infinite loop of camping onto the fake network again and again.

Some methods have been proposed that suggest mechanisms for stopping the timer when the UE does not receive a fresh authentication request after a failed request earlier. But these methods do not take into consideration the cases of abnormal release or connection loss at the UE, such as for example, in scenarios such as a cell change, Radio Resource Connection (RRC), and so on. As a result, an effective method is required that takes into consideration failures at the lower level of the UE. In addition, the method needs to address the issue of identifying impersonator networks and preventing camping on such networks.

### SUMMARY OF THE INVENTION

Accordingly, the present invention has been designed to address the above and other problems occurring in the prior art, and provide at least the advantages described below.

An aspect of embodiments of the present invention is to identify impersonator 3G networks and prevent camping on such networks.

Another aspect of embodiments of the present invention is to stop authentication timers when there is a lower level failure at the UE.

Another aspect of embodiments of the present invention is to prevent a genuine cell from being barred by the UE.

According to an aspect of the present invention, a method for identifying a fake network in a User Equipment (UE) in a wireless communication network is provided. The method includes starting a timer corresponding to an authentication failure; determining if a fresh request for authentication is received from a network; checking if there is an authentication failure in a lower layer if the fresh request is not received from the network; stopping the timer if there is the authentication failure in the lower layer; updating a count value for the authentication; comparing the count value with a pre-set value; and barring a cell if the count value is greater than the pre-set value.

According to another aspect of the present invention, a User Equipment in a wireless communication network for identification of a fake network and preventing camping on the fake network is provided. The UE is configured with a timer; and a controller for determining if a fresh request for authentication is received from a network; checking if there is an authentication failure in a lower layer if the fresh request is not received from the network; stopping the timer if there is the authentication failure in the lower layer; updating a count value for the authentication; comparing the count value with a pre-set value; and barring a cell if the count value is greater than the pre-set value.

### BRIEF DESCRIPTION OF THE DRAWINGS

These and other aspects of the embodiments of the present invention described herein will be better appreciated and understood from the following detailed description, taken with reference to the accompanying drawings, in which:

FIG. 1 illustrates the architecture of a 3G network, according to embodiments of the present invention;

FIG. 2 illustrates a UE, according to embodiments of the present invention;

FIG. 3 illustrates a synchronization failure scenario, according to embodiments of the present invention;

FIG. 4 illustrates a Message Authentication Code (MAC) failure scenario, according to embodiments of the present invention;

FIG. 5 illustrates a cell change scenario, according to embodiments of the present invention;

FIG. 6 is a flow chart illustrating the method according to embodiments of the present invention; and

FIG. 7 illustrates data stored on a counter in a UE, according to embodiments of the present invention.

### DETAILED DESCRIPTION OF EMBODIMENTS OF THE PRESENT INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments of the present invention.

The embodiments of the present invention provide a method for identifying fake networks and thereby preventing camping on such networks.

The method provides intelligence to a UE in order to determine if a network is a genuine network. During network authentication at the UE, if there is a failure at the UE due to lower layer failure, the failure is detected by the UE. The UE then takes the necessary action to stop the authentication failure timers. Further, the UE maintains a count of the number of failures resulting at every cell of the network. When this count exceeds a pre-configured value then the corresponding cell may be barred by the UE. This method ensures that no cell is barred due to false indication or fake networks trying to impersonate the genuine network.

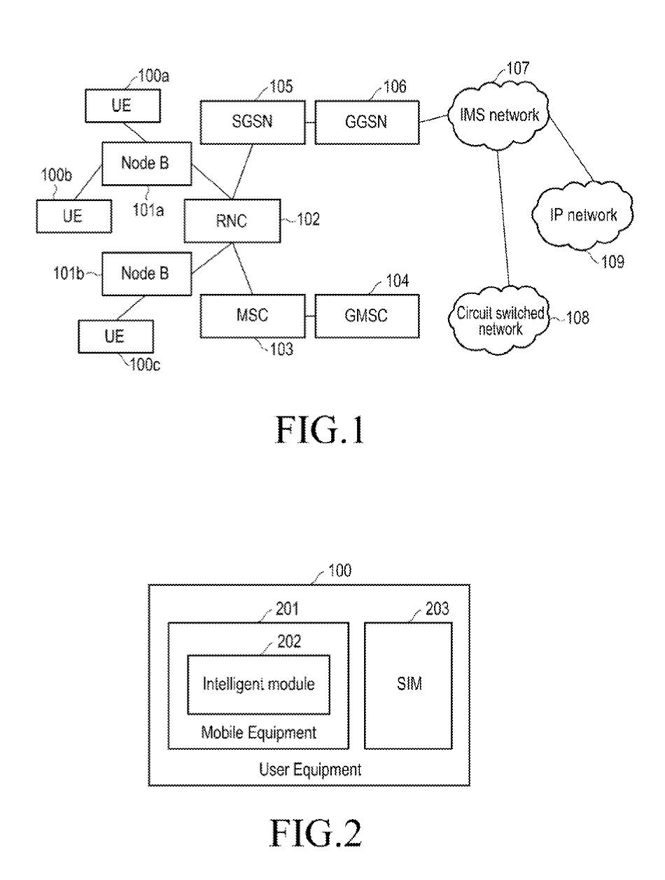

FIG. 1 illustrates the architecture of a 3G network, according to embodiments of the present invention. The 3G network comprises a plurality of networks connected together through various components to enable communication between the networks. The network comprises of plurality of UEs 100a, 100b and 100c that are connected to Node Bs 101a, 101b, a Radio Network Controller (RNC) 102, Mobile Switching Center (MSC) 103, Gateway Mobile Switching Center (GMSC) 104, Service GPRS Support Node (SGSN) 105, Gateway GPRS Support Node (GGSN) 106, IMS IP Multimedia Subsystem network 107, Circuit Switched Network 108, and IP Network 109.

The UEs 101a, 100b and 100c may also be referred to as Mobile Stations, or Mobile devices, interchangeably throughout the usage. The UE 100 is serviced by the Node B 101 and is provided with an intelligent module that resides within the UE 100. The intelligent module is the main component of the UE 100 that is responsible for identification of the fake networks. When the authentication request fails at the end of the UE 100 the intelligent module starts a timer. Further, if there is any lower layer failure in the UE 100 and the UE has not yet received a fresh authentication request then the timer is stopped. Further, the UE 100 ensures that the responses and requests are handled so as to prevent a genuine cell from being barred.

The Node Bs 101a, 101b serve the UEs 100 and are responsible for sending and receiving request to and from the UE 100 to the network.

The Radio Network Controller (RNC) 102 is a governing element in the UMTS Radio Access Network (UTRAN) and is responsible for controlling the Node B 101a, 101b that are connected to it. The RNC 102 carries out radio resource management, some of the mobility management functions and is the point where encryption is done before user data is sent to and from the UEs 100. The RNC 102 connects to the Circuit Switched Core Network through a Media Gateway (MGW) and to the SGSN 105 (Serving GPRS Support Node) in the Packet Switched Core Network.

The MSC 103 and GMSC 104 are components of the circuit switched network domain. The MSC 103 and GMSC 104 enable the UEs 100 to communicate with the circuit switched network 108.

The SGSN 105 and GGSN 106 are components of the packet switched network domain. The SGSN 105 and GGSN 106 enable the UEs 100 to communicate with the IMS network 107.

The IP network 109 enables multimedia communication. The IP network 109 connects to various other networks such as the IMS network 107 and the circuit switched network 108.

FIG. 2 illustrates the UE, according to embodiments of the present invention. The UE 100 is provided with the intelligence in order to decide if the signal is from a genuine network or a fake network. The UE as depicted herein illustrates only the basic components meant for the purpose of the application; however, in other embodiments the UE 100 may also include other components present within a Mobile Station.

The UE 100 comprises the mobile equipment 201 with the intelligent module 202 residing within it and the Subscriber Identity Module (SIM) 203. The ME 201 is a portable, vehicle mounted, or hand held device. The ME 201 is uniquely identified by an IMEI (International Mobile Equipment Identity). The ME 201 is responsible for voice and data transmission and monitoring power and signal quality of surrounding cells for optimum handover.

The intelligent module 202 is responsible for handling the authentication timers, such as T3214/T3216 or T3318/T3320 or T3418/T3420 timers, in the case of a failure scenario. The intelligent module 202 issues signals to the timers to stop the timer when required. This may be required as a result of a lower layer failure such as a MAC failure, an RRC connection release, and so on. In such a case, the timer is stopped. This ensures that the UE 100 is camped on a genuine cell and not a fake cell.

The SIM 203 contains the International Mobile Subscriber Identity (IMSI). The SIM 203 allows user to send and receive calls and receive other subscribed services. Encoded network identification details are performed in the SIM. Further, the SIM 203 is protected by a password or PIN and can be moved from phone to phone and contains key information to activate the phone.

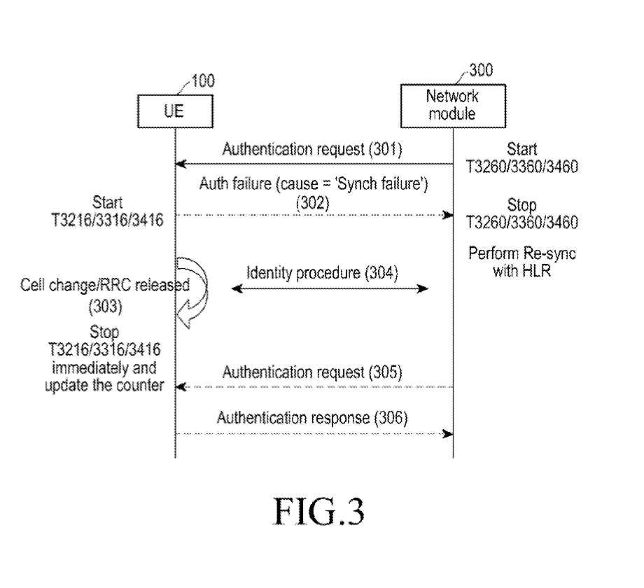

FIG. 3 illustrates a synchronization failure scenario, according to embodiments of the present invention. As depicted, an authentication failure during registration at the UE 100 in 3G networks is disclosed. The type of failure considered herein is a synchronization failure. The synchronization failure may result as the Universal Subscriber Identity Module (USIM) Sequence Number (SQN) value is lower than the SQN value maintained at an Authentication Center (AuC). The network module 300 sends an authentication request to the UE 100 in step 301 and starts a timer on itself i.e., T3260/3360/3460. In an embodiment of the present invention, the network module may be MSC 103, SGSN 105, and the like. The request may be in the form of the protocols employed in 3G network services. Considering there is a failure at the UE 100, which may be due to synchronization, the sync failure may result from a failure in establishing connectivity with the UE 100 by the network module 300. The UE 100 then starts a timer corresponding to the type of failure i.e., sync failure in this case so the timer T3216/3316/3416 is started. The UE 100 then sends an authentication failure response to the network module 300 in step 302. On receiving the response, the network module 300 stops the timer T3260/3360/3460.

Meanwhile, a check is a made in step 303 at the UE 100 side to determine if there is any lower layer failure at the UE 100. The failure may be a change of cell or an RRC connection release and so on. If the UE 100 detects such a failure then it immediately stops the timer T3216/3316/3416 so as to ensure that a fresh request for authentication is received from the network side, and to prevent unnecessary barring of a genuine cell. The UE 100 further updates a counter maintained within the UE 100. This counter maintains the count on the failures on every cell the UE 100 comes across. The identity procedure is performed in step 304. The network module 300 further sends a fresh authentication request to the UE 100 in step 305. The request contains fresh authentication vector variables. This time the UE is able to receive the request even though there may be a failure at the lower layer of the UE 100. The UE 100 then sends an authentication response back to the network module 300 in step 306. Thus, the process of registration is successful, and now the UE 100 can communicate with the network and exchange required information.

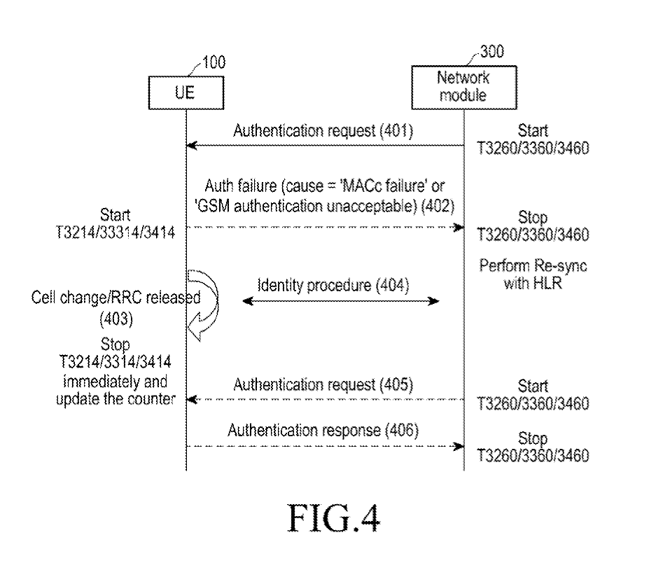

FIG. 4 illustrates a MAC failure scenario, according to embodiments of the present invention. As depicted, an authentication failure during registration at the UE 100 in 3G networks is disclosed. The type of failure considered herein is a Message Authentication Code (MAC) failure of Global System for Mobile (GSM) authentication unacceptable failure. In an embodiment of the present invention, MAC failure occurrence should be less as compared to SYNC failures in genuine networks because MAC is used to check if the camped Public Land Mobile Network (PLMN) has got an Authentication Vector (AV) from the Home network only. However, it is clearly possible that authentication failure could happen in genuine networks also.

The network module 300 sends an authentication request to the UE 100 in step 401 and starts a timer on itself i.e., T3260/3360/3460. In an embodiment of the present invention, the network module may be MSC 103, SGSN 105, and the like.

The request may be in the form of the protocols employed in 3G network services. Considering there is a failure at the UE 100, which may be a failure due MAC or GSM authentication failure, the MAC or GSM failure may result from an unacceptable form of the request, lower signal levels, code failure and so on. The UE 100 then starts a timer corresponding to the type of failure i.e., MAC or GSM failure in this case so the timer T3214/3314/3414 is started. The UE 100 then sends an authentication failure response to the network module 300 in step 402. On receiving the response, the network module 300 stops the timer T3260/3360/3460.

Meanwhile, a check is a made at the UE 100 side to determine if there is any lower layer failure at the UE 100 in step 403. The failure may be a change of cell or an RRC connection release, and so on. If the UE 100 detects such a failure then it immediately stops the timer T3214/3314/3414 so as to ensure that a fresh request for authentication is received from the network side and to prevent unnecessary barring of a genuine cell. The UE 100 further updates a counter maintained within the UE 100. This counter maintains the count on the failures on every cell the UE 100 comes across. The identity procedure is performed in step 404. The network module 300 further sends a fresh authentication request to the UE 100 in step 405. The request contains fresh authentication vector variables. This time the UE is able to receive the request even though there may be a failure at the lower layer of the UE 100. The UE 100 then sends an authentication response back to the network module 300 in step 406. Thus, the process of registration is successful, and now the UE 100 can communicate with the network and exchange required information.

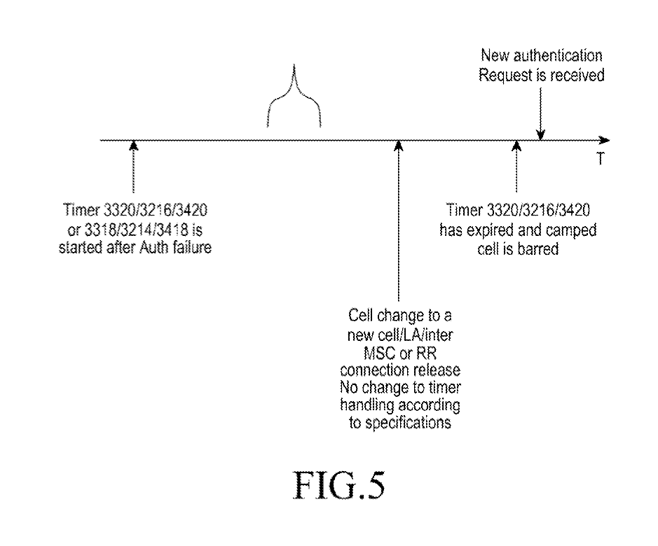

FIG. 5 illustrates the cell change scenario, according to embodiments of the present invention. As depicted, FIG. 5 shows the scenario where cell change happens and how it is addressed by the present invention. When there is a failure at the UE 100, the UE starts timer 3320/3216/3420 or 3318/3214/3418. When the timer is running, if there is an event of lower level failure such as cell change, or an RRC connection release, it is observed that the timer expires after the camped cell has been changed or if there is a release of RRC connection. In the prior art, in such a scenario the “good” cell will be blocked. In order to differentiate this scenario with a real hacker who is sending fake authentication requests to UE, an attempt counter is maintained by UE 100. The attempt counter maintains a count of the number of failures at every cell the UE 100 comes across. If the count value is above a threshold, then UE 100 will bar the corresponding cell. Also, this is valid in the case of the ping-pong effect between two cells. That is, an upper threshold is maintained in case of ping-pongs between two or more same cells. In this manner, the present method prevents the UE 100 from camping on a fake cell. Further, as the timer remains active the fresh authentication request obtained is received by the UE 100, which sends an acknowledgment corresponding to the request and the connection is successful.

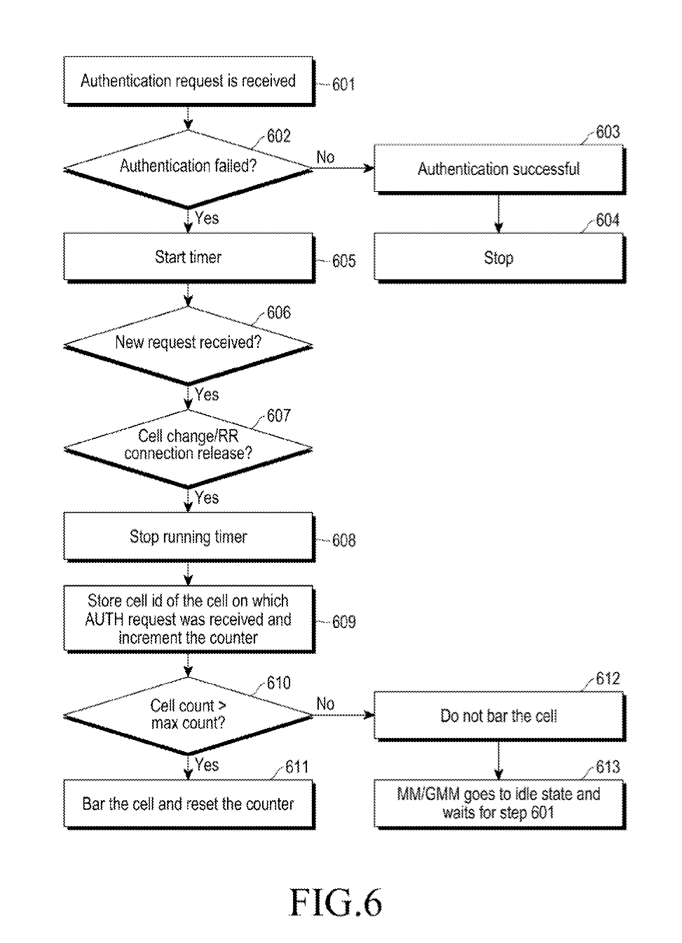

FIG. 6 is a flow chart illustrating the method according to embodiments of the present invention. The network sends an authentication request for registration with the UE 100 to the UE 100 in step 601. A check is made if there is a failure at the UE 100 in step 602. If there is no failure, then the authentication is determined to be successful in step 603, and the process stops in step 604. On the other hand, if there is a failure, the UE 100 starts a timer in step 605. The timer may correspond to the type of failure that has occurred, for example, a T3260/3360/3460 timer in the case of MAC failure. The UE 100 checks to see if any new request is received in step 606. Meanwhile, the UE 100 also determines in step 607 if there is a cell change or an RRC connection release at the end of the UE 100. If there is a cell change or an RRC connection release, the UE 100 immediately stops the timer in step 608. Further, the UE 100 stores the cell id of the cell on which the failure was received and increments the counter in step 609. The process continues and a check is made in step 610 at the counter to see if the count has reached a value above the pre-set value. In an embodiment of the present invention, the count may be set by the network. If the count is more than the maximum value, the cell is barred and counter is reset in step 611. If the count is not more than the maximum value, the cell is not barred in step 612. The Mobility Management (MM)/GPRS Mobility Management (GMM) goes into idle mode and waits in step 613 for step 601.

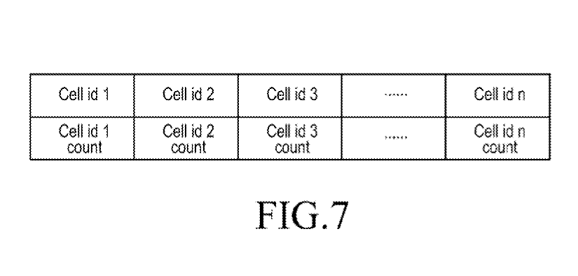

FIG. 7 illustrates data stored on a counter in a UE, according to embodiments of the present invention. The structure of storing the information in the counter is depicted. The counter stops the cell id's for every cell and the number of counts for each such cell. Here, “n” indicates the number of cells for which the context can be maintained by the UE 100, and the CELL_ID_n: is the id of the cell on which UE 100 received the authentication request. The cell_id_n_count: is the count maintaining the number of RRC connection failure/releases on the cell and cell changes to another cell. The MAX_count indicates the maximum defined count value below which cells will not be barred. This ensures that the UE 100 will detect a fake cell which is sending fake (replaying previously sent AUTH REQs or sending dummy AUTH REQs) authentication requests and then reducing the signal strength of the cell.

In an example, consider a case where authentication failure (SYNC failure) has happened and now timer 3216 is started. Before the timer expires, the UE 100 reselects to another cell, and before authentication request is received, the timer 3216 expires, and the UE will bar the genuine cell on which it is now camped. However, by implementation of the present method, the UE 100 may stop the timer and maintain the count list on the counter, and the count for that cell (cell_id_n_count) will be incremented. In this process the UE 100 may not bar the cell but may give the cell another chance for the UE 100 to receive service.

The embodiments disclosed herein can be implemented through at least one software program running on at least one hardware device and performing network management functions to control the elements. The elements shown in FIGS. 1, 2 and 3 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, those skilled in the art will recognize that the embodiments herein can be practiced with modification within the spirit and scope of the embodiments as described herein.

We claim:

1. A method for identifying a fake network in a User Equipment (UE), the method comprising:
starting a timer corresponding to an authentication failure at the UE;
determining if a fresh request for authentication is received from a network by the UE;
checking if there is an authentication failure in a lower layer at the UE if the fresh request is not received from the network;
stopping the timer if there is the authentication failure in the lower layer by the UE;
updating a count value for the authentication by the UE;
comparing the count value with a pre-set value by the UE; and
barring a cell if the count value is greater than the pre-set value by the UE.

2. The method as in claim 1, wherein the authentication failures comprise at least one of a synchronization failure, Message Authentication Code (MAC) failure, and Global Service for Mobile (GSM) Communication authentication unacceptable.

3. The method as in claim 1, wherein the fresh authentication comprises new authentication vector parameters.

4. The method as in claim 1, wherein the authentication failure in the lower layer includes at least one among a cell change and a Radio Resource Connection release.

5. The method as in claim 1, wherein the count value results from counting a number of authentication failures for each cell.

6. The method as in claim 1, wherein said pre-set value is determined by the network.

7. The method as in claim 1, wherein the network is a third generation (3G) network.

8. The method as in claim 1, wherein the network is a Long Term Evolution (LTE) network.

9. A User Equipment for identifying a fake network, wherein the UE comprises:
a timer; and
a controller for determining if a fresh request for authentication is received from a network, checking if there is an authentication failure in a lower layer if the fresh request is not received from the network, stopping the timer if there is the authentication failure in the lower layer, updating a count value for the authentication, comparing the count value with a pre-set value, and barring a cell if the count value is greater than the pre-set value.

10. The UE as in claim 9, wherein the authentication failure is at least one of a synchronization failure, Message Authentication Code (MAC) failure, and Global Service for Mobile (GSM) Communication authentication unacceptable.

11. The UE as in claim 9, wherein the fresh authentication request comprises new authentication vector parameters.

12. The UE as in claim 9, wherein the authentication failure in the lower layer includes at least one among a cell change, and a Radio Resource Connection release.

13. The UE as in claim 9, wherein the counter counts a number of authentication failures for each cell.

14. The UE as in claim 9, wherein said pre-set value is determined by said network.

15. The UE as in claim 9, wherein said network is a third generation (3G) network.

16. The UE as in claim 9, wherein said network is a Long Term Evolution (LTE) network.
